(19) United States
(12) Patent Application Publication
(10) Pub. No.: US 2012/0223000 A1
(43) Pub. Date: Sep. 6, 2012

(54) VACUUM ASSISTED OZONIZATION

(75) Inventors: Lih-Ren Shiue, Hsinchu County (TW); Tsei-Chin Chen Shiue, Hsinchu County (TW)

(73) Assignee: Lih-Ren Shiue, Hsinchu County (TW)

(21) Appl. No.: 13/040,480

(22) Filed: Mar. 4, 2011

(51) Int. Cl. C02F 1/78; C25B 9/00; C25B 1/13

(52) U.S. Cl. 210/192

(57) ABSTRACT

Ozone is a powerful and versatile oxidant that is good for many applications including sterilization of drinking water, rejuvenation of waste waters, and chemical syntheses. Most of the man-made ozone for the said uses comes from corona discharge of oxygen gas. From the aspects of simplicity, efficiency, voltage level and space area, generation of ozone by water electrolysis has all advantages over the discharge means. It requires an catalyst deposited on the anode of electrolyzer for generating ozone gas directly in water, and the anode material should be affordable, long-lived and reliable. For the said device to become commercially viable, the scale buildup, particularly calcium carbonate, on the cathodes must also be resolved. Tests have shown that the provision of a low vacuum over the electrodes of electrolyzer can assist the device to deliver a consistent ozone throughput for a long period of time. An economical, dependable and self-sustained O₃-water producing system is devised to fulfill individuals, households, communities, and industries on their water needs.

### FIELD OF THE INVENTION

This invention relates to a technique of generating ozone gas by water electrolysis using low DC voltages. More specifically, the invention relates to a consistent and continuous provision of ozonized water wherein the untreated intake water is the source of ozone gas for personal hygiene, drinking water sterilization, industrial water reuse and desalination.

### BACKGROUND OF THE INVENTION

Contaminants in water can be categorized as having chemical or biological nature. In the chemical contaminants, the species may belong to inorganic or organic materials. Together, they impart the contaminated water qualities that can be characterized by a number of major indicators, such as, TDS (Total Dissolved Solids), COD (Chemical Oxygen Demand), TSS (Total Suspended Solids), and TOC (Total Carbon Content). Whereas the biological pollutants include bacteria, viruses and microorganisms like algae, barnacles and spores. Ozone is recognized for its capability of fast and virtually complete eradication of the biological pollutants, and there is no byproduct of the disinfectant left after the treatment. Though at lower reaction rates, ozone can also abate the COD, dissolved and floated alike, in water. Ozone is even claimed to be used as a pretreatment for RO (reverse osmosis) desalination for removing salt and extremely fine particles, that is, for reducing TDS and TSS of seawater, as taught in the U.S. Pat. No. 5,741,416 issued to Tempest Jr.

Following the widely used corona discharge, the UV radiation of 185 nm wavelength is probably the second choice of technique for ozone generation. Each of the two popular techniques has its disadvantages. In the former, a high-purity oxygen is discharged in an electric filed of 20,000 volt or higher followed by gas-delivery and gas-dispersion into water under the strict control of a bulky equipment system. On the other hand, the said UV may generate ozone via the decomposition of oxygen or water. As the UV ray has a certain travel range, the amount of water that can be affected by the UV radiation is limited, worse yet, the lifetime of UV lamp is short and unpredictable. Using water as the source of ozone, generation of the gas via electrolysis of water has the merits of simplicity, efficiency, compactness and low-volt operation. Furthermore, since ozone is produced directly within water, there is no need of gas-delivery and gas-dispersion, and no air pollution, such as, NOx, which could be formed in the corona discharge. Regardless of the type of electrode materials, hydrogen gas is always generated at cathode and oxygen gas at anode at the electrolysis of water. A catalyst with high oxygen over-potential is required to be on the anode to induce the formation of O₃ besides O₂. Such catalytic behavior may be found in materials including platinum (Pt), β form lead dioxide (β-PbO₂), boron-doped diamond (BDD) and glassy carbon. In the said list of catalysts, Pt is the most frequently investigated as the catalyst on the anode for producing O₃.

In the Pt-based electrolytic cells, an ion-exchange membrane is often added for ozone generation as seen in the U.S. Pat. Nos. 5,607,562 issued to Shimamune et al; 6,210,643 to Shiota and 6,787,020 to Kanaya et al, just to name a few. Other Pt-based cells without the membrane can be found in U.S. Pat. No. 4,316,782 issued to Foller et al and U.S. Pat. No. 6,984,295 to Shiue et al. However, the former requires the use of a fluoroanion-containing electrolyte that limits its applications. Though the membrane can increase the O₃-yield of Pt anode and it can protect the catalyst from harmful anions, but the cell permits the use of a clean water only, otherwise, many water borne pollutants could shorten the service life of the expensive membrane. Even more costly material is the Pt catalyst, it is priced at $1 US or more per 1 cm² of Pt film at 3-μm thickness. Pt is so high in price that the industrial-size electrolytic cell for ozonization, whose electrode area measured in m², is beyond people's reach. Other catalysts in the foregoing list for the electrolytic O₃ are equally unsuitable for practical use, for instance, β-PbO₂ is environmentally hazardous, whereas BDD and glassy carbon are also expensive and inefficient. Thus, an economical and environment friendly catalyst is needed for the commercial ozonization using electrolytic O₃.

There are many articles in various journals study antimony doped tin oxide coated on titanium substrate (Ti/SnO₂—Sb₂O₅) as the anode for the electrolytic sterilization of drinking water and industrial waste stream. The work of Watts et al, J. Appl. Electrochem., Vol. 38, pp 31-37 (2008) is cited here as a reference. The article taught that the electrochemical oxidation of organic contaminants, like the phenol compounds, is due to the formation of hydroxy radical (.OH) catalyzed by SnO₂—Sb₂O₅ on water electrolysis. It needs ozone to react with hydrogen peroxide (H₂O₂) to form .OH in the advanced oxidation process (AOP). Thus, SnO₂—Sb₂O₅ is capable of forming an oxidant stronger than O₃ electrolytically. Furthermore, SnO₂—Sb₂O₅ is more affordable and more environment friendly than the aforementioned catalysts. In spite of its high efficiency on eliminating phenol pollutants, SnO₂—Sb₂O₅ is prevented from becoming a viable catalyst due to its short service life. This seems a common phenomenon, that is, electrode fouling, for all electrolytic cells involving the electrolysis of water. As the quality issue of the anode materials is important, the buildup of scale, calcium carbonate (CaCO₃) in particular, on cathodes also demands an effective solution. Several techniques have been proposed for controlling the scale formation and deposition, such as, anodic polarization in U.S. Pat. No. 4,256,556 issued to Bonnett et el, and polarity reversal in U.S. Pat. No. 5,916,490 to Cho, also in U.S. Pat. No. 4,087,337 to Bennett. Because of its vulnerability to reduction, SnO₂ can serve as anode only, which makes the polarity reversal inapplicable. While most people pay attention to the scale problem, the damages to anode and cathode caused by the adsorption of gas bubbles on the electrodes is overlooked. In the instant invention, a solution for overcoming the interference of scale and bubbles to the operation of electrolytic ozone will be elaborated.

### SUMMARY OF THE INVENTION

As one object, the instant invention has added one more metal, namely, nickel (Ni), to SnO₂—Sb₂O₅ for forming Sb and Ni doped tin oxide deposited on titanium (Ti/Ni, Sb—SnO₂). Using an adequate mole ratio among the three metal atoms, the ternary-metal oxide can catalyze the oxidation of water into oxygen and ozone at high ozone output. Ozone can be generated from any intake raw water without pre-adjustment. Because the lifetime of O₃ is longer than that of .OH, Ni, Sb—SnO₂ is more versatile than SnO₂—Sb₂O₅. Coupling with stainless steel as cathodes, the Ti/Ni, Sb—SnO₂ anodes can form a simple and effective electrolyzer to perform ozonization for various waters. In the said electrolyzer, the anodes and cathodes are stacked alternatively in parallel at 2 mm apart, and the cathodes are disposed at two ends of the stack so that the anodes may be utilized fully.

Generally, tin chloride (SnCl₄.4H₂O) is a preferred precursor for SnO₂, and the dopants are also in chloro-containing salts for making Ni, Sb—SnO₂. It is the easy dissolution of chloro-compounds in water for the materials chosen as the sources of the said three metals. Nevertheless, the chloro-containing precursors will emit hydrochloric acid (HCl) fume during the pyrolysis process of film deposition. As more Ni, Sb—SnO₂ film is prepared, more poisonous HCl fume will be generated. The acid fume is harmful to operators and the production equipments. Moreover, the Cl-residue left in the deposited film is detrimental to the quality of catalyst. It is another object of the instant invention to use non-chloro precursors for depositing the Ni, Sb—SnO₂ film on Ti substrate. While Sn and Ni are supplied by their carboxylic acid salts, Sb is obtained from its oxide. A preparation protocol is devised to dissolve two sparingly water-soluble precursors, namely, Sn salt and Sb oxide, into a clear aqueous solution for depositing the Ni, Sb—SnO₂ catalyst by pyrolysis.

As O₃ is formed via the catalysis of Ni, Sb—SnO₂ on anode, the throughput of O₃ is directly proportional to the total anode surface area disposed in the stack of electrolyzer. At a given water conductivity, the O₃ throughput is also decided by the current density that varies with the DC voltage applied across the anode and cathode. By providing a current density of 20 mA/cm² to the electrolyzer of the instant invention, it may produce O₃ at an output of 2 mg/cm²·min. In an O₃ generator equipped with 1 m² anode area, it may deliver 1.2 Kg of O₃ per hour upon applying 200A. In order to produce several kilograms of O₃ per day for municipal water sterilization or industrial waste water treatment, the operation current will be in the range of hundreds to thousand ampere. Therefore, it is yet another object of the instant invention to incorporate supercapacitor as the provider of large currents in the power supply system for the Ni, Sb—SnO₂ base ozone generator. Thanks to the power-amplifying capability of supercapacitor, a DC power supply may only need tens ampere current to charge the capacitor for hundreds ampere output. Incorporation of supercapacitor for fulfilling the power needs of the industrial O₃ generators will reduce the cost and size of power supplies required for the ozonization of massive water.

It is still yet another object of the instant invention to apply a suction over the electrodes of O₃ generator for removing gas bubbles from the electrodes resulting in the prevention of scale buildup. As long as the O₃ generator is in operation, the suction will be on for protecting the electrodes. Either a low-pressure vacuum pump or a Venturi tube is employed for creating the vacuum force required for gas removal. Since there is no barrier or diaphragm blocking the space between the anode and cathode of the generator, all gases formed will be simultaneously withdrawn in one stream from the generator chamber to the points of use. With scales and bubbles being evacuated from the electrode surface, the O₃ generator of the instant invention can perform ozonization at 24 hours a day for many days without interruption.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The instant invention is best understood by reference to the embodiments described in the subsequent sections accompanied with the following drawings.

FIG. 1 is a schematic diagram of a flow-though ozone generator in a basic configuration;

FIG. 2 is a schematic diagram of an independent and sustainable ozone generator for continuous and consistent provision of ozonized water;

FIG. 3 is a schematic diagram of Venturi injector for automatic removal of bubbles and gases from an ozone generator.;

FIG. 4 is two titration curves for determining the ozone concentration in water of the ozone generator of FIG. 1 operated with two different voltages.

### DETAILED DESCRIPTION OF THE PREFERRED EMBODIMENTS

There are four recognized methods for making ozone (O₃) under controlled conditions, namely, they are: corona discharge, UV radiation, electrolysis and radioactive radiation. The latter is complicated by the presence of harmful isotopes that prohibit the method from commercial use. As early as in 1840, O₃ was discovered as a byproduct of oxygen formed at the anode in electrolyzing sulfuric acid (H₂SO₄) in water. When scientists were looking for commercial use of the electrolytic cell for O₃ formation, they were occupied by the research of different electrolytes and corrosion-resistant anode materials. It is measured that the electrolytic formation of ozone, specified as electrolytic ozone (EO₃) thereinafter, can reach at least 10% current efficiency, which is significantly higher than the 4-5% efficiency of corona discharge (CD). In the CD operation, about 80% of the applied electric energy is lost as heat making the generation of ozone inefficient. Due to the misconception that a specific electrolyte is an essential component of EO₃, people believe that in-situ diffusion of ozone into ultra pure water is required for ozonization. As a result of the diffusion demand, EO₃ can only be in small units with operation cost higher than that of CD. The instant invention can transform the stereotyped status of EO₃ to commercially viable by presenting a novel technique for producing O₃ in high throughputs continuously and consistently using the following components
1. economical and high-ozone-yield electro-catalyst, namely, Ni, Sb—SnO₂,
2. intake raw water as the source of ozone,
3. supercapacitor for providing large currents for industrial applications, and
4. pump or Venturi for creating a vacuum force to remove gas bubbles.

In laboratory, ozone can be produced by electrolysis using a 9 volt battery, a pencil graphite rod cathode, a platinum (Pt) wire anode and a 3 molar (3 M) sulfuric acid electrolyte. The half cell reactions occurring at anode and cathode are as follows:

Anode: 3 H₂O→O₃↑+6 H⁺+6 e⁻(ΔE°=−1.53 V) (1)

2 H₂O→O₂↑+4 H⁺+4 e⁻(ΔE°=−1.23 V) (2)

Cathode: 2 H₂O+2 e⁻→H₂↑+2 OH⁻(ΔE°=0 V) (3)

Net: 5 H₂O→O₃↑+O₂↑+5 H₂↑ (4)

In the above reactions, reaction (1) and reaction (2) take place simultaneously at the anode but O₂ and O₃ are generated in different proportion. As indicated by the ΔE° values, O₂ is easier than O₃ for generation at anode. Hence, in the electrolysis of pure water using Pt anode, O₂ is more abundant than O₃. In fact, O₃ is often below the detection limit. When an electro-catalyst is present at the anode to drive the O₂ evolution to a more negative potential level, the evolution of O₃ will become noticeable and useful for treating water. As disclosed in U.S. Pat. No. 4,839,007 issued to Kotz et al., the O₂ overpotential (voltage at commencement of O₂ evolution) of Pt anode is 1.55V, and under the same test condition, the O₂ overpotential of anode coated with antimony doped tin oxide (Ti/SnO₂—Sb₂O₅) is in the range of 1.75-1.97 V. With higher O₂ overpotential, SnO₂—Sb₂O₅ will promote more O₃ formation than Pt. Also, in the treatment of waste water using electrochemical method, SnO₂—Sb₂O₅ decomposes a given organic pollutant at the same amount faster than Pt or β-PbO₂, the O₂ overpotential of the latter is 1.75V.

Tin oxide can be doped with F, Cl, Sb, Mo, W, Nb, Ta or a mixture of these elements to become conductive. By depositing the doped tin oxide film on a film-forming metal, such as Ti, the resulted anodes are widely used to reduce the COD of waste water via oxidants produced or direct oxidation on the anode. In SnO₂—Sb₂O₅ film, Sb mainly serves as a conductivity enhancer to tin oxide rather than catalyzing the formation of O₃. However, when a second dopant, namely, nickel (Ni), is added to SnO₂—Sb₂O₅, the ternary metal oxide, specified as Ni, Sb—SnO₂ thereinafter, can significantly enlarge the percentage of equ (1) in the anode reactions of water electrolysis, that is, the current efficiency of O₃ generation may reach as high as 30%. For attaining the said efficiency, the mole ratio of Sn:Sb:Ni should be in the ranges from 600:10:1 to 250:10:1. In addition, the concentration of tin ion, as Sn²⁺ or Sn⁴⁺, can be more than 1 molar (1 M), and the Ni, Sb—SnO₂ film is prepared by multiple cycles of brushing, dipping or spraying followed by thermal decomposition or pyrolysis.

Instead of using chloro-containing precursors for depositing Ni, Sb—SnO₂ film on Ti, the instant invention selects stannous oxalate (SnC₂O₄) for Sn, antimony (III) oxide (Sb₂O₃) for Sb and nickel acetate [Ni(CH₃COO)₂.4H₂O] for Ni. Both of the first two precursors are sparingly soluble in water. In U.S. Pat. No. 4,924,017 (Patent '017) issued to Kobashi et al., SnC₂O₄ is converted to water-soluble stannic acid [HO(SnO)CO₂COOH], a compound with acidity as strong as H₂SO₄, by reacting with hydrogen peroxide (H₂O₂). Patent '017 is incorporated in its entirety as a reference in the instant invention. Meanwhile, Sb₂O₃ can also be dissolved together with SnC₂O₄ in the exothermic oxidation by H₂O₂. In order to prepare a transparent solution containing the 3 precursors for depositing Ni, Sb—SnO₂ film on Ti, the following precautions are adopted:
1. the purity of precursors should be at least 99.8%,
2. the addition of H₂O₂ to the slurry of precursors should be in portion by portion to avoid over heating that may char the chemicals, and
3. no organic solvent should be added.

As important as the control of solution preparation, the pyrolytic process for converting the solution to the desirable Ni, Sb—SnO₂ film also demands the compliance with a protocol. The key operation parameters include: drying and sintering temperatures, rates and lengths of heating, oxygen supply, annealing control and cleansing of ashes on the coating. Though stannic acid is a strong acid, it permits the deposition of SnO₂ film on stainless steel. Had tin chloride (SnCl₄.4H₂O) been used as the precursor of Sn, no SnO₂ film could be plated on stainless steel. Using stainless steel as substrate for titanium, the cost of anodes for EO₃ may be significantly reduced.

### Flow-Through Ozone Generators

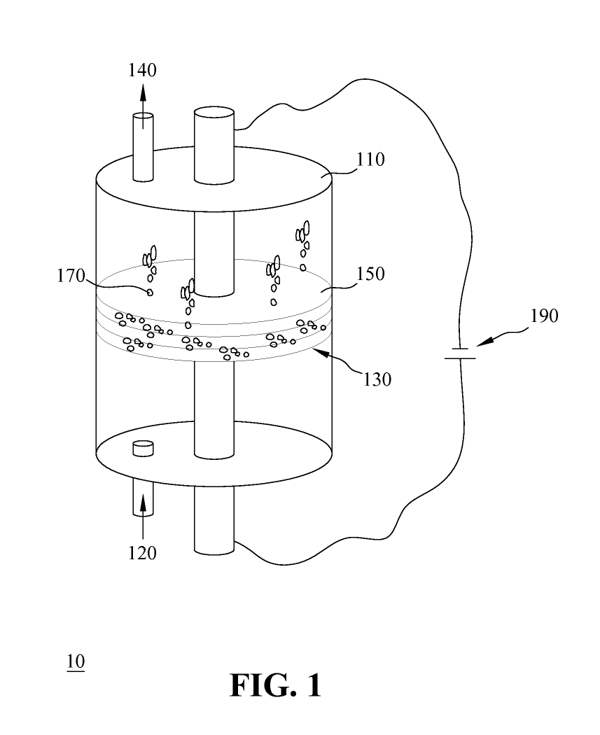

FIG. 1 shows one of the basic forms of electrolyzer for O₃ generation as proposed by the instant invention. As seen in FIG. 1, the O₃ generator 10 is composed of a housing 110 that contains a stack of electrodes formed by juxtaposing two circular anodes represented by 130 and two circular cathodes represented by 150. A DC power supply 190 is used for applying a voltage to the electrode stack. Both of anodes and cathodes have a number of perforated holes, as represented by 170, for water to flow through, and for gas bubbles to evolve. During electrolysis, there is more gas bubbles evolved at the edges than other areas of electrodes, which is known as edge effect. There are only circular spacers, not shown in FIG. 1, disposed in the gaps of 3 pairs of anodes and cathodes to prevent electric shorts. Without pre-adjustment, raw water can enter the electrolyzer 10 from inlet 120, and it can exit the electrolyzer casing from outlet 140. As water passing through the electric field of electrode stack, it will be electrolyzed into micro bubbles of O₃, O₂ and H₂. Being a simple design as FIG. 1, the O₃ generator 10 is good for assessing the quality of Ni, Sb—SnO₂ film as prepared, as well as for evaluating a formula of coating solution and a deposition protocol, but it is inadequate for long-term ozonization of waters.

Virtually, in all electrolytic cells using hard water as solvent, the formation of white calcium carbonate (CaCO₃), calcium hydroxide [Ca(OH)₂], or similar precipitates of magnesium is inevitable. Many places in the electrolytic cells are available for the white fine particles to settle, but they intend to deposit on the cathodes leading to cathode passivation, As the accumulation of scale on the cathode has reached a certain thickness, the desired electrolysis will be completely stopped and the applied energy is wasted. For regenerating the cathode, washing the electrolyzer with hydrochloric acid (HCl) to dissolve the scale is probably the only practical solution. However, the acid dissolution of scale will interrupt the production, and frequent washings may be required if an extremely hard water is employed for electrolysis. Furthermore, the ions of iron (Fe²⁺) and manganese (Mn²⁺) present in ground water and seawater of many ports in the world are higher than 0.02 ppm, and these ions can deposit on the anodes as oxides. When the said metals deposit on anode in the form of Fe₂O₃ or MnO₂, it can not be removed by any acid, any base, or electricity like polarity reversal resulting in the loss of anodes. Only by depositing new Ni, Sb—SnO₂ film on the original substrates that are cleaned by sand blasting, can the anode be revived. Thus, a convenient and effective way to protect the electrodes, anode and cathode alike, and to impart the generator the capability of delivering long-term and reliable ozonization is required for the EO₃ of the instant invention.

Generation of hypochlorite (ClO⁻) by electrolyzing seawater or sodium chloride solutions has been commercialized for ship ballasts and cooling water equipments for anti-fouling and marine growth prevention. Because calcium is the fifth abundant element in seawater, the electrolytic generation of ClO⁻ must be interfered by the scale accumulation on the cathodes as well. In U.S. Pat. No. 4,510,026 (Patent '026) issued to Spaziante, a low vacuum, or 0.7 atmospheres (10.3 lb/in², or 10.3 psi), is applied intermittently to a hypochlorite generator for overcoming the scale interference. Patent '026 is also included in its entirety as a reference in the instant invention. During the evolution of H₂ on the cathode, titanium to be exact, in the hypochlorite generator, hydrogen atom (.H) is born first, and the radical is adsorbed on the cathode followed by two combination reactions to H₂ and a metal hydride, respectively, as described in equations (5) to (7):

H₂O+e⁻→.H_{ad}+OH⁻ (5)

2.H_{ad}→H₂ (6)

Ti+4.H→TiH₄ (7)

Equations (5) to (7) show that the adsorption of .H radical on cathode initiates the formation of titanium hydride resulting in the embrittlement of Ti structure and degradation of cathode. In the same scenario, the adsorption of O₂ and O₃ bubbles on anode may cause the deactivation of Ni, Sb—SnO₂ film, as well as the degradation of anode. Applying a reduced pressure over the electrolyzer submerged in water, less gas will stay in water according to Henry's Law, and the gas can grow into larger bubbles as well. There is a “blasting effect” along with the removal of gas bubbles from the electrode surface under a reduced pressure. As the bubbles leave the electrodes, any deposit thereon will be lifted up and carried away by water flow, this is the said “blasting effect”. Not only the scale buildup is eradicated, but the degradation of electrodes is also prevented by the application of vacuum over the electrolyzer.

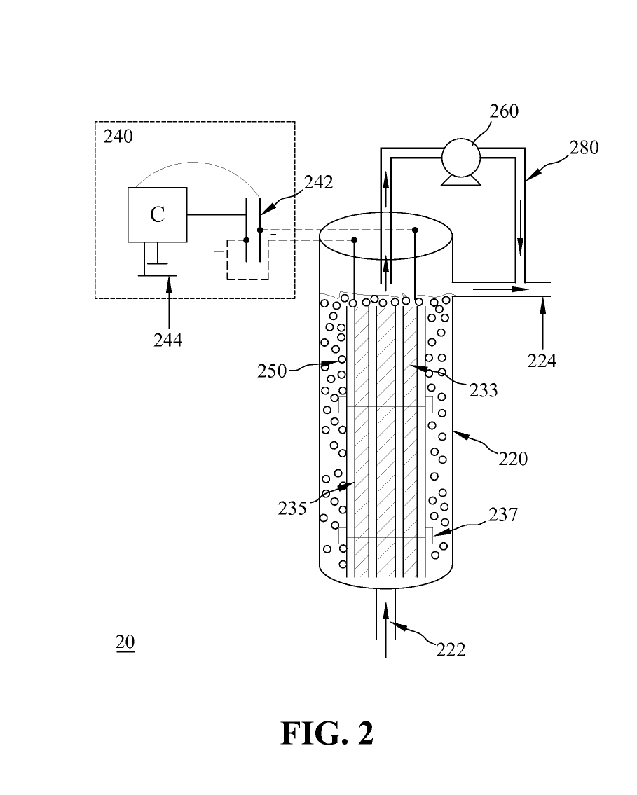

FIG. 2 shows a preferred embodiment of the EO₃ generator system of the instant invention. There are 3 sections of operation in the O₃ generator 20 of FIG. 2. They are the electrolyzer and electrolysis chamber, the DC power unit and the vacuum suction unit. A stack of electrodes constitute the electrolyzer wherein 3 anodes, symbolized by long bars with slanted lines and numbered as 233, are sandwiched by 4 cathodes, the clear long bars numbered as 235. Each electrode has a plural number of perforated holes thereon (not shown in FIG. 2), and all electrodes are in parallel separated with a gap of 2 mm fixed by circular insulator-spacers (also not shown in FIG. 2). All anodic plates are linked electrically in a pack, so are all cathodic plates in another electrical pack, for connecting to the positive and negative poles of an outer DC power supply, respectively. Misconnection of the electrical leads with the poles is absolutely prohibited. As no mesh, screen, net, web, membrane or diaphragm is placed among the electrodes, the anodic gases, O₂/O₃, and cathodic gas, H₂, can fully mix, which has no detrimental effect to the functions of O₃. Ti, in 98-99% purity, is a preferred substrate for the anode, and many iron-base metals including irons, carbon steels, alloy steels and stainless steels can be selected as the substrate for cathode. For treating surface waters, nickel, stainless steel, or aluminum may also be used as the anodic substrate, whereas Ti, aluminum, copper, nickel or magnesium alloy may serve as the cathodic substrate. Both of anode and cathode are flat plates in 0.8-1.0 mm thickness, 7.5 or 10 cm width and 25 or 40 cm length. Nevertheless, other sizes and configuration of electrodes can be fabricated to meet the application needs. In the generator of FIG. 2, O₃ is produced in micro-size bubbles that can not be duplicated by any man-made disperser. Because the O₃ reactivity is affected by its bubble size, ozonization by the EO₃ of the instant patent is highly efficient.

Without pre-adjustment, raw waters, represented by 250, containing no sticky materials, such as, oils, fats, greases, inks, or varnishes, can enter the electrolysis cell from the inlet 222. In the electric field of electrolyzer, the intake water will be electrolyzed into O₃ with other gases, and contaminants of water may be subjected to in-situ ozonization, direct oxidation or direct reduction on anodes and cathodes, respectively, or a combination of the foregoing reactions. After the said treatments, the effluent can exit the reaction chamber from the side outlet 224 as ozonized water or purified water. A water pump (not shown in FIG. 2) may be employed to push water in and out of the electrolyzer 20. The flow of water may also be driven by the pressure in a public tap-water supply line or by gravity force. Block 240, in dotted square, is a DC power supply unit comprised by one or a bank of supercapacitors 242, a control circuit C, and a DC power source 244. Batteries, renewable energies, fuel cells, generators or city lines may serve as the power source 244. By the maneuver of C, 244 can apply a pre-determined low-current to charge the supercapacitor 242, then, the capacitor can deliver a current, which is larger than the charging current, to the two electrical leads of electrolyzer 20 for producing a desirable output of ozone. Based on the targeted O₃ outputs, the dimensions and the power rates of the DC power source and those of supercapacitor, as well as the delivery times or delivery frequency of the supercapacitor power to the O₃ generator can be designed and implemented accordingly.

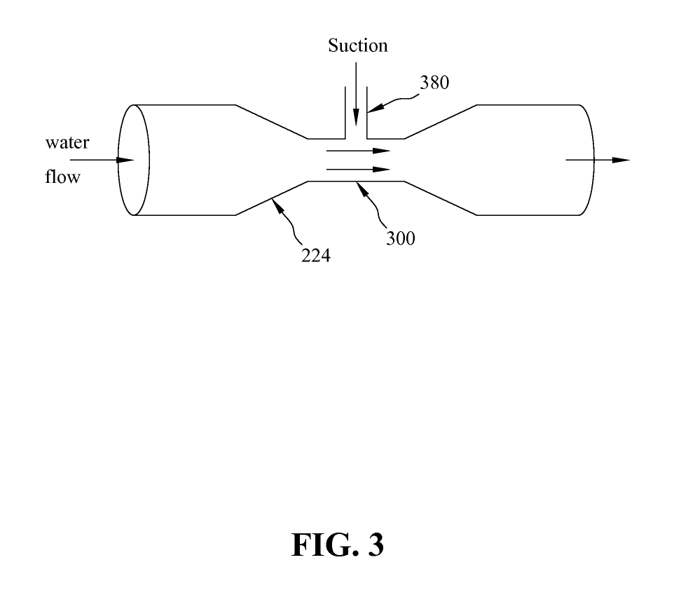

As seen in FIG. 2, a vertical electrolyzer is fully submerged in water, and a room is reserved above water for O₂/O₃/H₂ to escape therein. A vacuum pump 260 is employed to apply a reduced pressure over the electrolyzer to draw the escaping gas and bubbles from the chamber into the effluent tube 224 via the suction line 280. Even the O₃ extracted is mixed with water and water vapor, the mixture can still join the effluent as an ozonized water for various usages. Instead of going to the effluent, the O₃—H₂O mixture or only the ozone gas after the removal of moisture by a dehumidifying device can be delivered to other points of use. During ozonization, some fine precipitate may also be generated in water. Thus, adding a filter (not shown in FIG. 2) that can remove sub-micron particles to the generator 20 of FIG. 2 will make the system more sustainable. Furthermore, the vacuum pump 260 may be replaced by Venturi tube for the purpose of bubble removal. FIG. 3 shows a design of Venturi injector that may simultaneously replace the effluent tube 224 and the suction line 280 of FIG. 2. By constricting the inner diameter of outlet tube 224 in a cone shape section 300, wherein water must increase the speed for reducing its pressure leading to a partial vacuum created in tube 380, which is enlarged for clarity sake. Venturi injectors can be operated in a pressure range of 1 to 250 psi (or 0.068 to 17.01 atm), and only a minimum pressure difference is required to initiate the vacuum for sucking gas. Without moving parts, Venturi injectors are maintenance free and electricity free. In facts, they are used for ozone injection in water as seen in the U.S. Pat. No. 5,741,416 to Tempest Jr, U.S. Pat. No. 6,132,629 to Boley, U.S. Pat. No. 6,869,540 to Robinson et al, U.S. Pat. No. 7,416,660 to van Leeuwen et al, and U.S. Pat. No. 7,501,055 to Liou, just to name a few.

### Supercapacitors (SC's)

Supercapacitor (SC) is a passive energy storage device, as well as a power-amplifying electronics. SC can store electric energy between the levels of batteries and conventional capacitors, the latter are the second most used component in electronic circuits. Due to its 3 to 6 orders more of energy stored than the regular capacitors, SC earns the title of “super”. For its large energy content, SC is also named as ultracapacitor. From the perspective of energy storage mechanism, most SC's rely on the adsorption of ions in a double layer formed at the interface of solid and liquid, namely, the electrode and electrolyte. Hence, the said SC's are called double layer capacitor or electric double layer capacitor (EDLC). It is the ion adsorption, a physical process, and double layer structure imparting SC the following unique properties:
Anode and cathode are made identical making SC no polarity before charging. After charging, the electrodes allow electric-short discharge and polarity reversal.
Electric energy is directly filled into, or extracted from, SC without conversion. Thus, the charge and discharge of SC is fast, in seconds, and highly efficient, 90% or higher.
Energy transfer of SC is 100% reversible, the device has many-year lifetime and it is maintenance free.
SC can be operated at 10% extra to the rated voltage, and its current level of charge and discharge has no limitation.
SC can amplify an input current by 10 times or more. A power step-up circuit based on SC can be constructed for low cost and high reliability.
SC is low in cellular voltage (generally, 2.5 V/cell), but it can be fabricated in a single device with working voltage as high as the demands of applications.

Contrary to the high operation voltage and low current of corona discharge (CD), EO₃ is a technique of high operation current and low voltage. Hence, the characteristics of SC are in perfect match with the power requirements of EO₃. As the price of DC power supply for EO₃ is determined by the current outputs of the equipment, hence, the capital cost and the maintenance fee of EO₃ is profoundly affected by the operation-current needs. Using the advantage of SC, the said costs can be significantly reduced for a power supply with low current outputs can be employed. Incorporation of in the electrolytic ozone is first claimed in U.S. Pat. No. 6,984,295 (Patent '295) issued to Shiue et al. Comparing to Patent '295, the instant invention has made the following improvements:
(1) Reduction of anode cost by replacing Pt with Ni,Sb—SnO₂ catalyst.
(2) Assurance of EO₃ performance by using vacuum for gas removal.
(3) Fabrication of single SC's in the required voltages and capacities.

In line with item (3), SC's can be made in-house in 10V×40F to 30V×20F or other larger power ratings to meet various application needs, such as, public water sterilization, industrial cooling-water antifouling, wastewater treatments and desalination pretreatment. Followings are two practices of the EO₃ system of the instant invention Example 1.

An ozone generator as FIG. 1 is constructed using a stack of 2 anodes and 2 cathodes in 10 cm diameter (10 cmφ), and it is disposed in a plastic housing of 12 cmφ by 20 cm height (volume=2.2 L). The total anode area (4 sides) A is calculated as follows:

A=πr²×4=(3.1416) (5 cm)²(4)=314.2 cm²

4 L (liter) tap water with TDS of 200 ppm is circulated at 4 L/min between the generator and a reservoir. Two different DC voltages, namely, 12V and 16V, are applied to the generator separately. The ozone concentration in water formed under each operation voltage is determined every 5 minutes using potassium iodide (KI) titration at 0.1 equivalent (0.1 N) titrant concentration and starch as the indicator. In the titration, iodide ion (F) is oxidized by O₃ to iodine molecule (I₂) that forms a blue complex with starch. With the drop-wise addition of KI, an intense blue color will appear to signify the end point of titration. Table 1 lists the calculated concentrations of O₃ dissolved in water per 5-minute interval, wherein two operation voltages are employed in sequence.

TABLE 1
O₃ Concentration in Water Formed by Electrolysis
at 12 V and 16 V, and Calculated from KI Titration
(4 L tap water, 4 L/minute flow, anode area 314.2 cm²)

O₃ Concentration (ppm)

| Time | 12 Volt | 16 Volt |
|---|---|---|
| (min) | 3.18 mA/cm² | 6.37 mA/cm² |
| 5 | 1.05 | 1.38 |
| 10 | 1.33 | 1.71 |
| 15 | 1.59 | 1.93 |
| 20 | 1.79 | 2.10 |
| 25 | 1.90 | 2.27 |
| 30 | 1.99 | 2.45 |
| 35 | 1.99 | 2.48 |
| 40 | 2.04 | 2.49 |
| 45 | — | 2.49 |
| 50 | — | 2.49 |

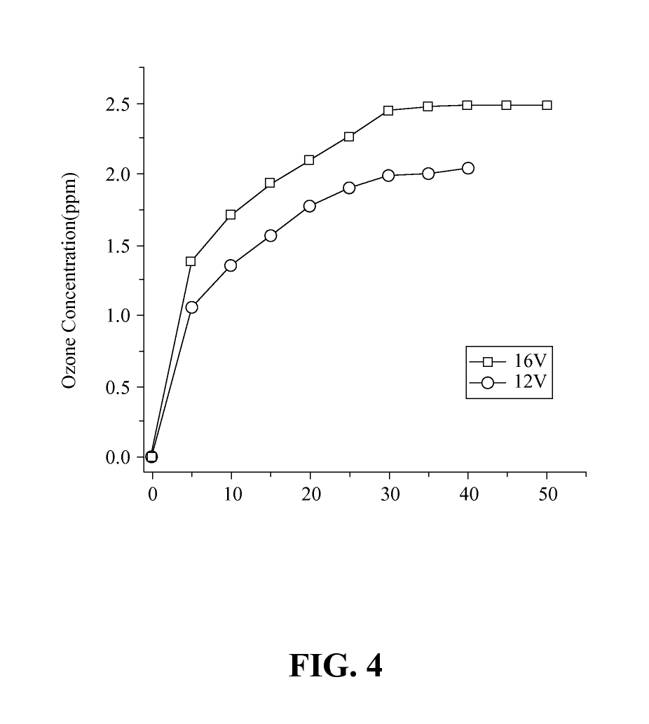

By plotting the ozone concentration as ordinate against time abscissa, FIG. 4 is resulted. As seen in the figure, the O₃ concentration is leveled off towards the 30-minute mark. Due to no pressure applied to the generator and reservoir, O₃ can escape into atmosphere freely, therefore, a limit to the dissolution of O₃ in water appears as a flat line in FIG. 4. Ozone (O₃) has a lifetime of about 20 minutes in water, and the gas has a low solubility in water, which is affected by temperature and water content, such as, the presence of oxidizable species. Roughly, about 0.3% of the total O₃ product may dissolve in water, and the rest is in the gas state. Either form of O₃ is effective for sterilization and reduction of COD. As a disinfectant, a low ozone concentration of 0.4 ppm is sufficient for a total kill of most-seen bacteria and pathogens. Hence, O₃ formation using 16V consumes energy excessively for sterilization purpose. Nevertheless, a much higher O₃ dose is required for the COD abatement of industrial wastewaters, which will need a high operation power. By the O₃ concentration formed at 16V in Table 1, the yield of water-borne O₃ per unit area and unit time is assessed as 0.004-0.006 mg/cm²·min, or the overall O₃ yield is in 1.3-2 mg/cm²·min assuming that 0.3% of the total O₃ product dissolves in water. Table 1 indicates that the current density is an important factor to the O₃ yield, other parameters including the quality of catalyst film deposited, the inhibition of scale buildup and the prevention of electrode decay are more crucial to the current efficiency, power consumption, long-term reliability and efficacy of ozonization using the EO₃ technique of the instant invention.

An ozone generator using 1 anode sandwiched by 2 cathodes with 2 mm gap equipped with a vacuum pump is constructed. Different from the vertical generator of FIG. 2, the 8 cmφ×38 cm generator of Exp 2 is placed horizontally. Moreover, about 25% area of the electrodes in this example is intentionally exposed in air for observing the progress of scale deposition on the cathodes. All electrodes are in 7.5 cm width by 25 cm length and 1 mm thickness. 4 L of tap water with TDS of 140 ppm is circulated between the generator and a reservoir at 200 L/hour. A DC voltage of 7.8V is applied to the electrodes in conjunction with a vacuum of 50 cmHg (or 0.66 atm, 9.67 psi) from a 40 W pump powered by 110V×60 Hz. Table 2 summarizes the observations and measurements of each operations in the proof of principle test:

TABLE 2
Proof of Principle of Vacuum Assisted Ozonization

| # | Operations | Observation/Measurement | Remarks |
|---|---|---|---|
| 1 | Electrolysis | A thin and spotty white deposit | Electrolysis must go with |
| | without vacuum | on the cathodes | vacuum. |
| | for 30 min | | |
| 2 | Electrode exposed | More deposit on the edges of | Water flow removes |
| | | electrodes near the air-water | particles. |
| | | interface | Filter can help. |
| 3 | Water | After 3-hour electrolysis of 4 L | Except sterilization, O₃ can |
| | hardness/pH | tap water, TDS = 77 ppm, pH = | soften water or Ca/Mg |
| | | 6.5 | removal |
| 4 | 600-hr Non-stop | Current drops from 1.65 A to | The performance is |
| | Electrolysis | 1.55 A (6% decay), very thin | consistent and the anode |
| | | white coat on cathode, anode | has a long lifetime. |
| | | appears intact. | |
| 5 | O₃ concentration | 2 ppm measured on meter | The power usage is lower |
| | in water at 600^{th} | OM-1000 by biotek-ozone | than that of Table 1. |
| | hour | (www.biotek-ozone.com) | |

In the item 4 of Table 2, during the 25-day straight electrolysis, only 3 L of water is replaced daily. In other words, the fresh water provides more Ca²⁺ and Mg²⁺ to challenge the anode. Besides the cathodes, white deposit is also found on the water conveying tubes. This indicates that ozone can turn Ca/Mg ions into precipitates, and a filter with sub-micron pores can remove the fine particles to maintain the cleanness of O₃ generator. The removal of bubbles by vacuum is effective on protecting the Ni, Sb—SnO₂ anode, the low operation voltage, 7.8V, has contributed to the lifetime of anode as well. As claimed by Stucki et al in Pharmaceutical Engineering, Vol. 25, pp 1-7 (2005), in PEM (proton exchange membrane) O₃ cells used for delivering 1 to several hundreds m³ of sterilized water to pharmaceuticals production, the anodes, β-PbO₂, have been operated for many years without degradation. Except PEM and pure intake water, a low operation voltage, 3-4 V, is also a factor to the longevity of anode. As only 0.3 to 12 g O₃/hr output is needed in the foregoing reference, the O₃ generator can be operated at such low voltages. It must take the quality of intake water and the ozonization purpose into account for determining the optimal operation volt for EO₃. In any situation, the operation voltage of EO₃ should be under 24V DC. A thumb of rule is always applicable to all applications using EO₃, that is, the operation voltage should be kept as low as possible. Exp 2 provides a direction for the following novel usages of ozonization:
O₃ can provide sterilization and COD/TDS reduction of waters.
O₃ can replace the chemicals used hugely in RO desalination.
O₃ can perform as a pre- and post-purifier for water treatment.

The application of ozone (O₃) is virtually unlimited. All viable applications of O₃ are determined by the cost of gas generation and long-term performance. In addition to affordability, simplicity, compactness and versatility, EO₃ based on Ni, Sb—SnO₂ film as the anodic catalyst also offers a long service-life with the assistance of vacuum. Under the protection of vacuum, the said EO₃ can be integrated with electrocoagulation (EC) into a combinatory technique for a synergistic effect that is more effective in treating waters than either EO₃ or EC alone. When EC adopts iron as anode for delivering Fe²⁺ as a coagulant, the ion will be oxidized by O₃ to ferryl species {[Fe(IV)O]²⁺} and ferrate (FeO₄²⁻). These high oxidation states of iron, Fe(IV) and Fe(VI), have an oxidation rate at three orders faster than that of O₃. Especially among all methods for eliminating the COD contaminants, the combination of EC and EO₃ can provide the quickest and the most complete results. New integration of the EO₃ with other water-treatment techniques for reducing the cost of water treatment is yet to be developed. Through the vacuum transferral of ozone gas from the reaction chamber of EO₃ to its counterpart, the integration can be successfully accomplished.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An ozone generator for electrolyzing water to ozone comprising:
at least one anode;
at least one catalyst on the said anode;
at least one cathode;
at least one casing;
at least one inlet on the said casing for water to flow therein;
at least one outlet on the said casing for water to flow out;
at least one DC power source;
at least one supercapacitor;
at least one electronic controller for controlling the said power source to charge the said supercapacitor, and for controlling the discharge of the said supercapacitor;
at least one electric lead for connecting the said anode to the positive pole of the said power source;
at least one electric lead for connecting the said cathode to the negative pole of the said power source;
at least one vacuum device;
at least one port on the said casing for the said vacuum device to apply vacuum.

2. The ozone generator for electrolyzing water to ozone as claimed in claim 1, wherein the said anode may select from a group of metals containing Ti, Ni, Al and stainless steels.

3. The ozone generator for electrolyzing water to ozone as claimed in claim 1, wherein the said cathode may select from a group of metals containing carbon steels, alloy steels, stainless steels, Ti, Al, Cu, Ni and magnesium alloy.

4. The ozone generator for electrolyzing water to ozone as claimed in claim 1, wherein the said anodic catalyst is tin oxide (SnO₂) doped with antimony (Sb) and nickel (Ni).

5. The ozone generator for electrolyzing water to ozone as claimed in claim 4, wherein the said catalyst is comprised by three metals Sn, Sb and Ni in atomic ratio of Sn:Sb:Ni from 600:10:1 to 250:10:1.

6. The ozone generator for electrolyzing water to ozone as claimed in claim 4, wherein the said tin oxide (SnO₂) is derived from tin oxalate (SnC₂O₄).

7. The ozone generator for electrolyzing water to ozone as claimed in claim 6, wherein the said tin oxalate (SnC₂O₄) has a concentration of 1 molar (1 M) or higher.

8. The ozone generator for electrolyzing water to ozone as claimed in claim 1, wherein the said DC power source may select from batteries, renewable energies, fuel cells, generators or city lines.

9. The ozone generator for electrolyzing water to ozone as claimed in claim 1, wherein the said DC power source provides a DC voltage to the generator under 24V.

10. The ozone generator for electrolyzing water to ozone in claim 1, wherein the said supercapacitor has a working voltage of 10V or higher, and a capacity of 20F or higher.

11. The ozone generator for electrolyzing water to ozone as claimed in claim 1, wherein the said electronic controller can regulate the said supercapacitor on its charge current, current output and discharge frequency.

12. The ozone generator for electrolyzing water to ozone as claimed in claim 1, wherein the said vacuum device is a vacuum pump or Venturi injector.

13. The ozone generator for electrolyzing water to ozone as claimed in claim 12, wherein the said vacuum device can provide a reduced pressure of 0.7 atm or lower,
